(19) United States
(12) Patent Application Publication
(10) Pub. No.: US 2025/0346120 A1
(43) Pub. Date: Nov. 13, 2025

(54) FINISH PANEL TO HOUSE AN NFC MODULE

(71) Applicant: Ford Global Technologies, LLC, Dearborn, MI (US)

(72) Inventors: Alma Elisa Lopez Rayon Morales, Puebla (MX); Aida Fuentes Manzanero, León (MX); Alejandro Nieto Gaspar, Toluca (MX); Luis Flores Alonso, Mexico City (MX); Ricardo Galicia Lopez, Tlalpan (MX)

(73) Assignee: Ford Global Technologies, LLC, Dearborn, MI (US)

(21) Appl. No.: 18/658,425

(22) Filed: May 8, 2024

(51) Int. Cl. B60K 37/20; B62D 25/14

(52) U.S. Cl. CPC B60K 37/20; B62D 25/14; B60K 2360/46; B60K 2360/84

(57) ABSTRACT

An instrument panel assembly includes a substrate that is configured to be secured to a vehicle body structure. An intermediate structure is secured to the substrate. The intermediate structure includes an opening therethrough and at least one connector extending from a rear side of the intermediate structure adjacent the opening. A Near Field Communication (NFC) module positioned in the opening of the intermediate structure. An outer panel is secured to the intermediate structure, and extends over the opening in the intermediate structure and over the NFC module. The outer panel has an outer surface comprising a decorative class A surface.

### FIELD OF THE DISCLOSURE

The present disclosure generally relates to a Near Field Communication (NFC) module in vehicles, and in particular to an arrangement that does not require a separate bracket for mounting an NFC module adjacent to an instrument panel.

### BACKGROUND OF THE DISCLOSURE

Vehicles may utilize NFC modules to enable a user to access and operate a vehicle without a physical key. Various mounting arrangements for NFC modules have been developed.

### SUMMARY OF THE DISCLOSURE

An aspect of the present disclosure is an instrument panel assembly for motor vehicles. The instrument panel assembly includes an instrument panel substrate that is configured to be secured to a motor vehicle body structure in front of a driver's space. An intermediate structure is secured to the substrate whereby a rear side of the intermediate structure faces the main instrument panel substrate and a front side of the intermediate structure faces away from the main instrument panel substrate. The intermediate structure includes an opening therethrough and a plurality of barbed (e.g. snap fit) connectors extending from the rear side of the intermediate structure around the opening. The instrument panel assembly further includes a Near Field Communication (NFC) module positioned in alignment with the opening of the intermediate structure. The NFC module is retained by the barbed connectors. An outer panel is secured to the intermediate structure, and extends over the opening in the intermediate structure and over the NFC module. The outer panel has an inner surface facing the NFC module, and an outer surface facing away from the NFC module. At least a portion of the outer surface of the outer panel may comprise a decorative class A surface.
The intermediate structure may comprise a molded polymer structure, and the decorative class A surface of the outer panel may comprise an in-mold grain.
The barbed connector may comprise a snap fit connector that may be integrally formed with material extending around the opening in the intermediate structure.
The barbed snap fit connectors may comprise flexible post structures having tapered distal end surfaces and retaining surfaces that extend transverse from inner edge portions of the tapered distal end surfaces. During installation of the NFC module, the NFC module may initially engage the tapered distal end surfaces and flex the post structures, followed by the post structures snapping back to an unflexed shape in which the retaining surfaces engage a surface of the NFC module to thereby retain the NFC module to the intermediate structure.
The NFC module may have an oblong rectangular shape formed by a perimeter surface extending between front and rear surfaces of the Near Field Communication (NFC). The perimeter surface may include end segments extending between opposite side segments. The intermediate structure may include at least two barbed snap fit connectors adjacent each side segment of the perimeter surface of the NFC module.
The retaining surfaces of the barbed snap fit connector may contact the rear surface of the NFC module.
The front side of the intermediate structure may include a surface around the opening in the intermediate structure that is substantially coplanar with the front surface of the NFC module.
The surface of the intermediate structure around the opening may be disposed at an acute angle relative to a vertical plane when the instrument panel assembly is installed in a vehicle. The opening through the intermediate structure may be rectangular, and may include upper and lower edges adjacent upper and lower edges, respectively, of the NFC module. The intermediate structure may include a plurality of upper and lower barbed snap fit connectors adjacent the upper and lower edges, respectively, of the opening through the intermediate structure. The flexible post structures of the upper and lower barbed snap fit connectors may each define a length and a width in cross section, and the lower barbed snap fit connector may have widths that are greater than widths of the upper barbed snap fit connectors.
The main instrument panel substrate may include a plurality of openings and at least one retaining clip structure adjacent each opening. The intermediate structure may include a plurality of tapered protrusions projecting from the rear side of the intermediate structure. The tapered protrusions may be disposed in the openings, and may engage the retaining clip structures to secure the intermediate structure to the main instrument panel substrate.
The intermediate structure may include a plurality of upright wall sections having attachment openings therethrough, and the outer panel may include a plurality of connecting structures that project from the inner surface of the outer panel. The connecting structures may be received in the attachment openings of the intermediate structure.
The outer panel may include locating surfaces adjacent to the connecting structures, and the locating surfaces may engage the upright wall sections of the intermediate structure to position the outer panel relative to the intermediate structure in at least a fore-aft direction. The outer panel may include a plurality of locating posts that are received in the locating openings of the intermediate structure to at least vertically position the outer panel relative to the intermediate structure. The connecting structures may comprise polymer heat stakes that are melt-formed to fix the outer panel to the intermediate structure.

Another aspect of the present disclosure is a method of fabricating an instrument panel structure of a motor vehicle. The method includes forming a main instrument panel substrate and an intermediate structure. The intermediate structure has an opening therethrough and a plurality of connectors adjacent the opening. The method further includes forming an outer panel having an outer surface comprising a decorative class A surface. An NFC module is secured to the intermediate structure by moving the NFC module into engagement with the connectors. The method further includes attaching the intermediate structurer to the outer panel, and attaching the intermediate structure the main instrument panel substrate.
The intermediate structure may be attached to the outer panel utilizing a heat staking process whereby the intermediate structure and the outer panel are brought into contact and at least a portion of the intermediate structure or the outer panel is then melted.
The NFC module may be secured to the intermediate structure after the intermediate structure is attached to the outer panel.
The method may include electrically connecting the NFC module to a main wire harness of the instrument panel.
The intermediate structure may be attached to the main instrument panel substrate after the NFC module is secured to the intermediate structure.
The intermediate structure may comprise a polymer material, and the connectors may comprise integrally formed barbed connectors that project from a rear side of the intermediate structure.
The NFC module may be secured to the intermediate structure by causing the NFC module to slidably contact the barbed connectors to flex the barbed connectors whereby the NFC module snaps in place with barbs of the barbed connectors engaging a surface of the NFC module to thereby retain the NFC module in place on the intermediate structure.

Another aspect of the present disclosure is motor vehicle including a body structure having an interior space including a driver's space. An instrument panel assembly is disposed in the interior space in front of the driver's space. The instrument panel assembly includes a main instrument panel substrate secured to the body, and an intermediate structure secured to the main instrument panel substrate. The intermediate structure has an opening therethrough and at least one resilient snap connector disposed adjacent to the opening. A Near Field Communication (NFC) module is secured to the intermediate structure by the at least one resilient snap connector adjacent to the opening. An outer panel is secured to the intermediate structure and extends over the opening in the intermediate structure and over the NFC module. The outer panel has an inner surface facing the NFC module and an outer surface facing away from the NFC module, wherein at least a portion of the outer surface comprises a decorative class A surface.
The NFC module may have a rectangular perimeter, and the opening in the intermediate structure may be rectangular. The NFC module may be closely received in the opening of the intermediate structure. The intermediate structure may comprise a polymer material, and the at least one resilient snap connector may comprise a plurality of cantilevered barbed connectors extending from a rear side of the intermediate structure adjacent to at least two opposite side edges of the rectangular opening. The NFC module may be operably connected to a main instrument panel wiring harness by an electrical line extending from the NFC module to the wiring harness.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a partially fragmentary perspective view of a portion of an instrument panel of a vehicle according to an aspect of the present disclosure;

FIG. 2 is a cross sectional view taken along the line II-II of FIG. 1;

FIG. 2A is an enlarged fragmentary view of the connectors of FIG. 2;

FIG. 3 is a perspective view of an intermediate structure and NFC module according to an aspect of the present disclosure showing a rear side of the intermediate structure and NFC module;

FIG. 4 is a partially fragmentary perspective view of an intermediate structure and NFC module according to an aspect of the present disclosure showing a front side of the intermediate structure and NFC module;

FIG. 5 is a partially fragmentary view showing a rear side of the intermediate structure with the cover panel positioned on the intermediate structure prior to heat staking;

FIG. 5A is a cross sectional view taken along the line VA-VA, FIG. 5;

FIG. 5B is a cross sectional view taken along the line VB-VB, FIG. 5;

FIG. 6 is an enlarged fragmentary view of a portion of the intermediate structure and the NFC module of FIG. 5; and

FIG. 7 is a partially fragmentary cross sectional view showing attachment of the intermediate structure to a main instrument panel substrate.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

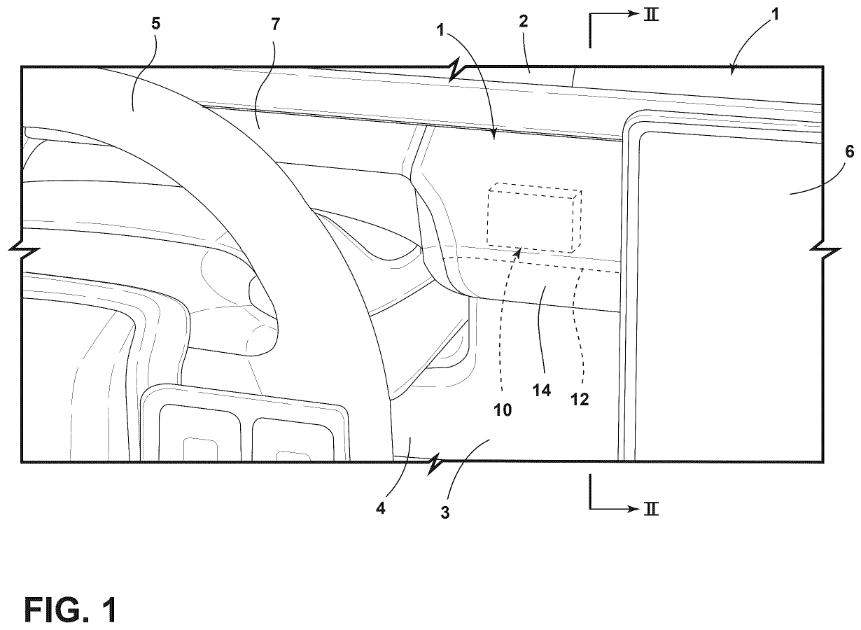

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the terms “or” and “and/or,” when used in a list of two or more items, means that any one of the listed items can be employed by itself, or any combination of two or more of the listed items can be employed. For example, if a composition or device is described as containing or comprising components A, B, and/or C, the composition or device can contain (include) A alone; B alone; C alone; A and B in combination; A and C in combination; B and C in combination; or A, B, and C in combination. If a composition or device is described as containing or comprising components A and/or B and/or C, the composition or device can contain (include) A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” “including” or any other variation thereof, are intended to cover a non-exclusive inclusion, such that a process, method, article, or apparatus that includes or comprises a list of elements does not include only those elements but may include other elements not expressly listed or inherent to such process, method, article, or apparatus. An element preceded by “comprises . . . a” or “includes . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

With reference to FIG. 1, a motor vehicle 1 may include a body structure 2 having an interior space 3 which includes a driver's space 4. A steering wheel 5, display screen 6 and instrument panel 7 may be positioned in the interior space 3 adjacent to, or in front of, the driver's space 4. As discussed in more detail below, instrument panel assembly 7 may include a Near Field Communication (NFC) module 10 that is mounted to an intermediate structure 12 behind an outer cover panel 14. NFC module 10 may be positioned between steering wheel 5 and display screen 6. NFC module 10 may comprise a known device that is configured to permit a user to enter and/or operate motor vehicle 1 without use of a conventional key. NFC modules are generally known in the art. Thus, a more detailed description concerning the function of the NFC module is not believed to be required.

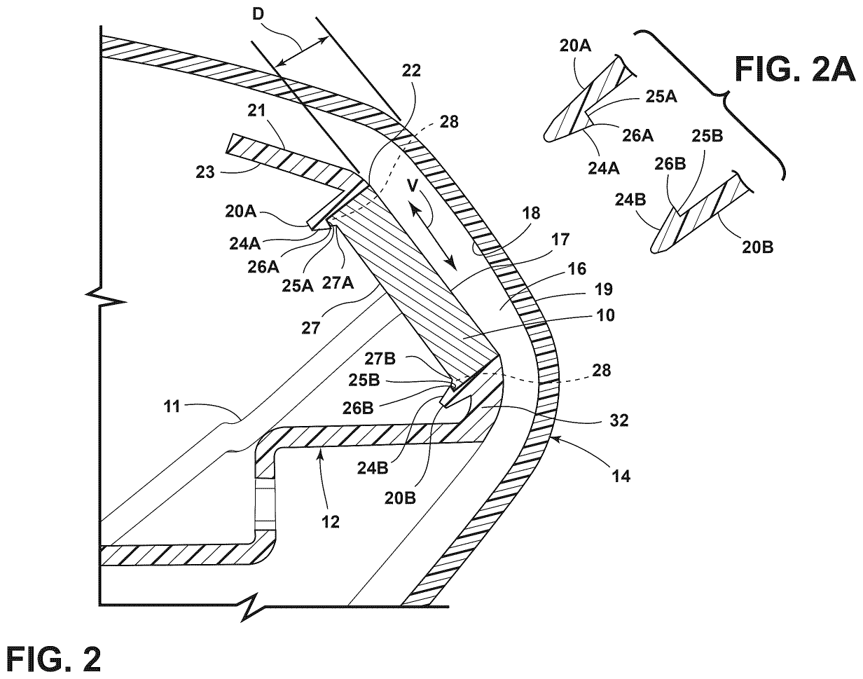

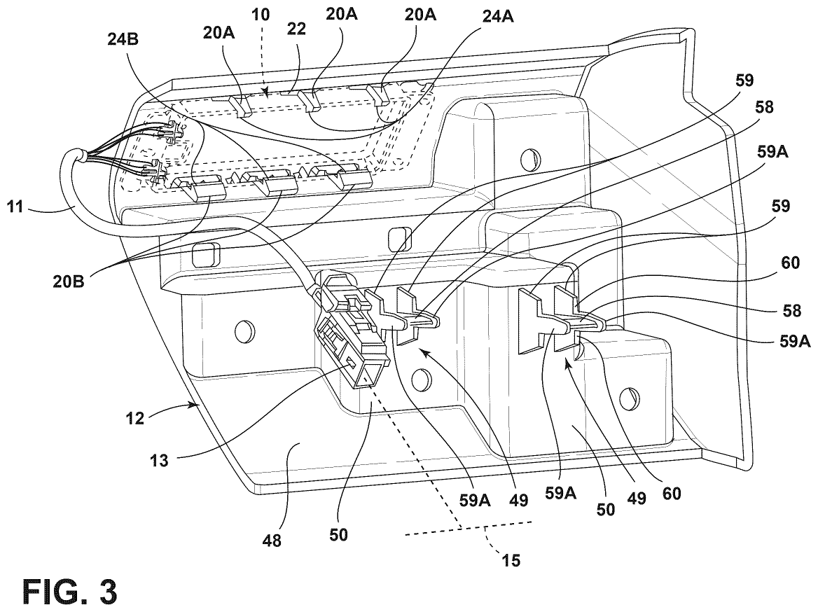

With further reference to FIG. 2, when assembled, a front surface 17 of NFC module 10 may be spaced apart from a rear surface 18 of cover panel 14 to form a gap 16. Front surface 17 of NFC module 10 is preferably spaced apart from a front or outer surface 19 of cover panel 14 a distance “D.” The distance D is preferably no more than about 10 mm. However, the distance D could be greater than 10 mm. At least a portion of outer surface 19 of cover panel 14 may comprise a Class A surface, which may include In Mold Grain Lamination (IMGL), a plastic-wrap component. NFC module 10 may include a cable 11 having a receptacle 13 (FIG. 3) that operably connects the NFC module 10 to an instrument panel wiring harness 15.

With further reference to FIGS. 3-5, NFC module 10 is retained in, or in alignment with, an opening 22 of intermediate structure 12 by a plurality of connectors 20A and 20B, which may comprise barbed connectors. As discussed below, intermediate structure 12 may include crush ribs 28 that engage NFC module 10 to prevent movement of NFC module 10 in the direction of arrow “V.” The connectors 20A and 20B may comprise barbed snap fit structures in the form of flexible post structures having tapered distal end surfaces 24A and 24B, respectively (FIG. 2A). The connectors 20A and 20B also include retaining surfaces 25A and 25B, respectively, that extend transverse from inner edges 26A and 26B, respectively. As discussed in more detail below, during installation of the NFC module 10 to intermediate structure 12, the NFC module 10 initially engages (e.g. contacts) the tapered surfaces 24A and 24B and flexes the post structures 20A and 20B, followed by the post structures snapping back to an unflexed shape in which retaining surfaces 26A and 26B engage a rear surface 27 of NFC module 10 at edge portions 27A and 27B, respectively (FIG. 2). Intermediate structure 12 may comprise a molded polymer material, and the connectors 20A and 20B are preferably integrally formed with intermediate structure 12.

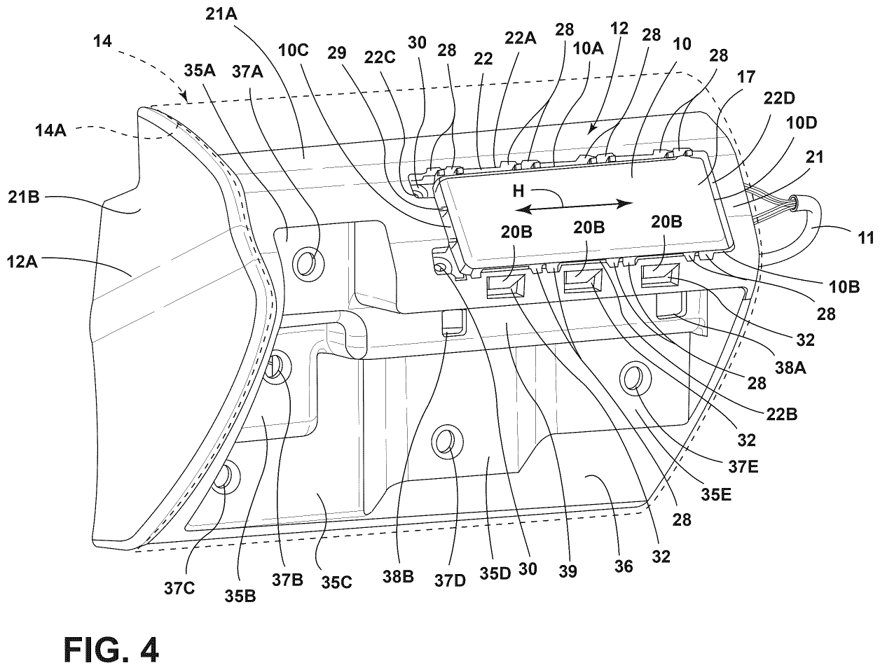

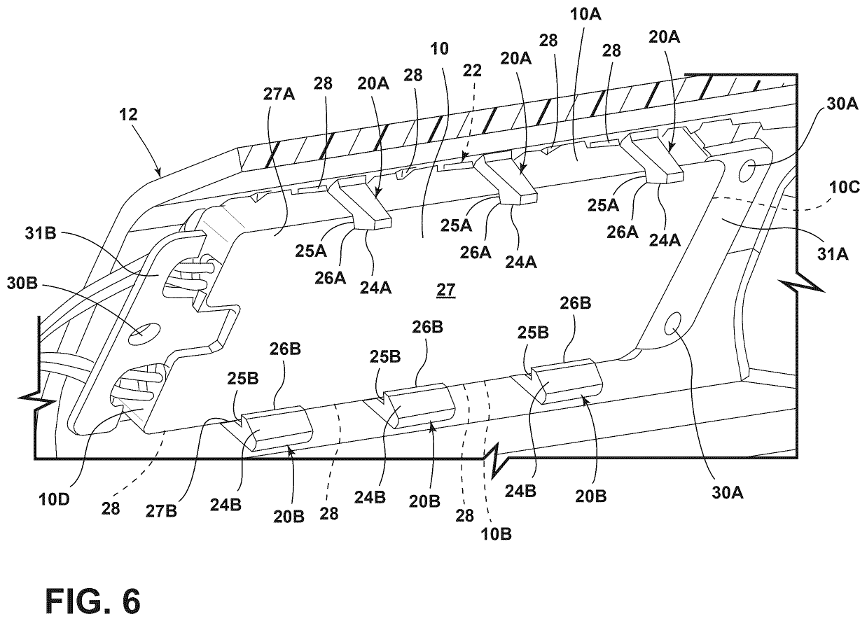

As shown in FIGS. 4 and 6, opening 22 through intermediate structure 12 may have a generally rectangular shape with upper and lower edges 22A and 22B, respectively, and end edges 22C and 22D. NFC module 10 has a generally rectangular perimeter shape with upper and lower side surface segments 10A and 10B respectively, and end surface segments 10C and 10D. Surface Segments 10A-10D extend between front and rear surfaces 17 and 27 of NFC module 10. Intermediate structure 12 may include a plurality of locating structures such as crush ribs 28 that engage surfaces 10A and 10B of NFC module 10 to thereby vertically position the NFC module 10 in opening 22 of intermediate structure 12. Crush ribs 28 may be configured to provide an interference fit with surfaces 10A and 10B of NFC module 10 to prevent movement of NFC module 10 in the direction of arrow “V” (FIG. 2) in opening 22 whereby NFC Module 10 is securely positioned in opening 22 of intermediate structure 12. Edge 22C of opening 22 may include a stop surface 29 (FIG. 4) that engages end surface 10C of NFC module 10 to thereby locate the NFC module 10 horizontally in opening 22 and prevent movement of NFC module 10 in the direction of the arrow “H.” NFC module 10 may have a known design that includes a flange 31A and 31B having openings 30A and 30B, respectively to provide for mounting NFC module 10 utilizing threaded fasteners. However, threaded fasteners are not required in view of the connectors 20A and 20B and locating structures such that threaded fasteners and mounting openings 30A and 30B are not normally utilized in accordance with an aspect of the present disclosure. However, threaded fasteners (not shown) could be utilized in openings 30A and/or 30B. As shown in FIG. 4, intermediate structure 12 may include openings 32 adjacent connectors 20B. When NFC module 10 is installed, front surface 17 of NFC module 10 is preferably approximately coplanar with a front surface 21 of intermediate structure 12 in the area around the opening 22 of intermediate structure 12.

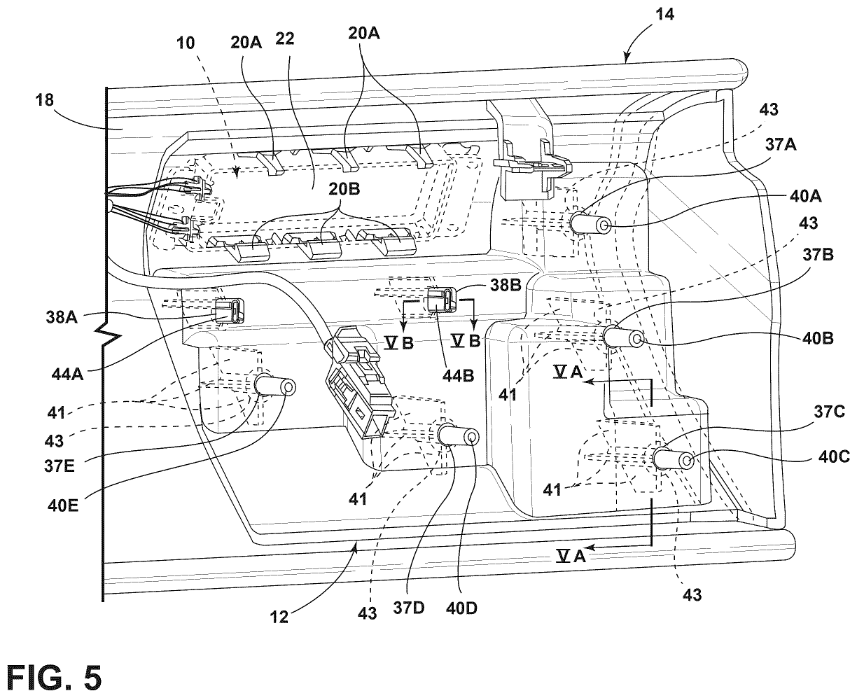

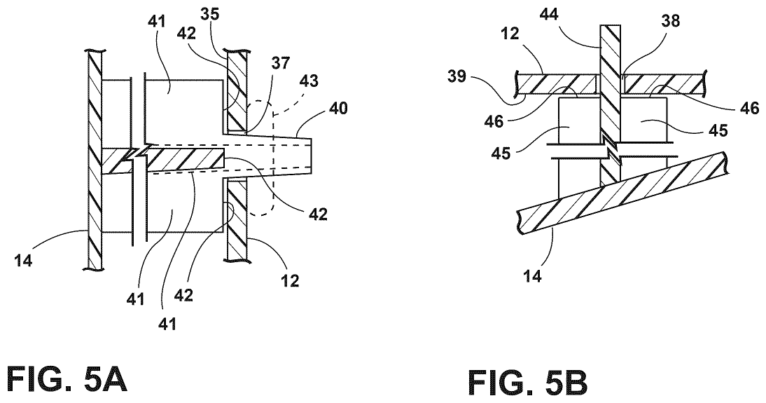

With reference to FIGS. 4 and 5, intermediate structure 12 includes a plurality of upright surface portions 35A-35E on a front side 36 of intermediate structure 12. Openings 37A-37E are located on the upright surface portions 35A-35E, respectively. Surfaces 35A-35E may be flat. Intermediate structure 12 further includes pin openings 38.

With reference to FIG. 4, a first portion 21A of surface 21 of intermediate structure 12 may be positioned behind cover panel 14 when instrument panel 7 is fully assembled. When assembled, an end edge 14A of cover panel 14 may abut an upright end panel 12A of intermediate structure 12 whereby surface 21B of intermediate structure 12 is exposed. Surface 21B is preferably a class A surface, and surface 21A is preferably a non-class A surface. For example, surface 21B may optionally include IMGL to match outer surface 19 of cover panel 14.

With reference to FIG. 5, during assembly, posts 40A-40E of cover panel 14 are inserted into openings 37A-37E of intermediate structure 12, and locating pins 44A and 44B of cover panel 14 are positioned in pin openings 38A and 38B, respectively. Pins 44A and 44B may be closely received in pin openings 38A and 38B, respectively, whereby cover panel 14 is accurately positioned relative to intermediate structure 12 in a plane transverse to the axes of pins 44A and 44B. With reference to FIG. 5A, when intermediate structure 12 and cover panel 14 are assembled, end surfaces 42 of ribs 41 contact surfaces 35 of intermediate structure 12 adjacent to openings 37, and end surfaces 46 of ribs 45 of pins 44 contact surface 39 of intermediate structure 12 adjacent to pin openings 38 to thereby position the cover panel 14 relative to intermediate structure 12 in a fore-aft direction. It will be understood that the small gaps between surfaces 35 and 42 (FIG. 5A) and between surfaces 39 and 46 (FIG. 5B) are shown for clarity, but these gaps are preferably not present when intermediate structure 12 and cover panel 14 are fully assembled. After the intermediate structure 12 and cover panel 14 are positioned relative to one another, the ends of the posts 40 are melted (heat staked) to form a deformed retaining portions 43 to thereby securely interconnect intermediate structure 12 and cover panel 14.

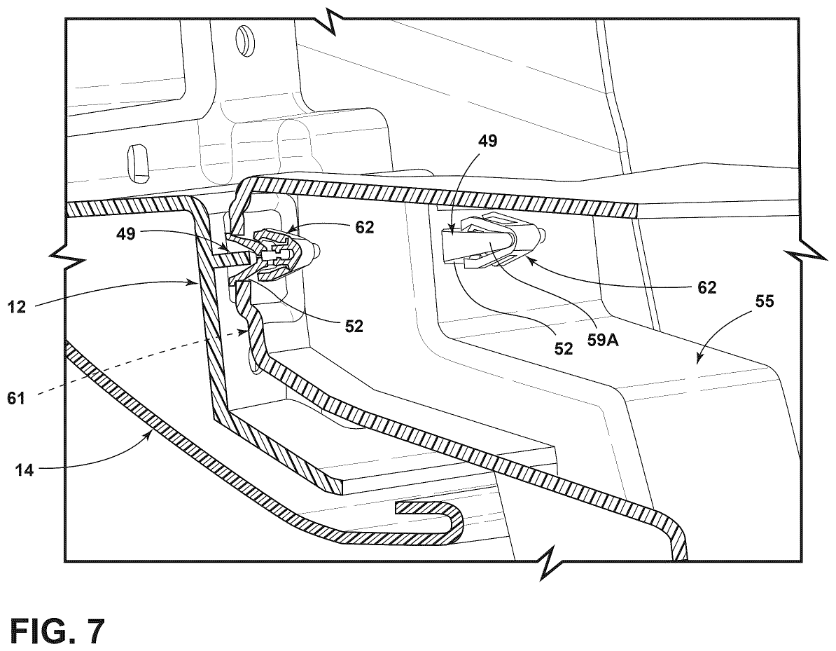

With reference to FIGS. 3 and 7, intermediate structure 12 includes a plurality of upright surfaces 50 and attachment surface 49 that protrude from upright surfaces 50. The attachment structures 49 include upright sidewalls 59, and a horizontal wall 58 that extends between the upright sidewalls 59. Upright sidewalls 59 include locating surfaces 60 and end portions 59A.

With reference to FIG. 7, intermediate structure 12 is secured to a main instrument panel substrate 55 by inserting end portions 59A of attachment structures 49 of intermediate structure 12 into openings 52 of main instrument panel substrate 55. When assembled, clips 62 engage horizontal wall 58 of attachment structures 49 to securely connect the intermediate structure 12 to the main instrument panel substrate 55. Clips 62 may comprise conventional medium retention polymer clips. When installed, end surfaces 60 of upright sidewalls 59 of attachment structures 49 engage a front surface 61 (FIG. 7) of main instrument panel substrate 55 to thereby position the intermediate structure 12 relative to the substrate 55 in a fore-aft direction. The end portions 59A of attachment structures 49 may be closely received in openings 52 in main instrument panel substrate 55 to thereby position the intermediate structure 12 relative to the main instrument panel substrate 55. When assembled, the rear side of intermediate structure 12 (e.g. surface 2) faces main instrument panel substrate 55, and a front side of intermediate structure 12 (e.g. surface 21) faces away from main instrument panel substrate 55) The main instrument panel substrate 55 may be fixed to the vehicle body structure 2 such that the intermediate structure 12 and cover panel 14 are thereby fixed relative to the vehicle body structure 2.

The intermediate structure 12, cover panel 14, and main instrument panel substrate 55 may comprise one-piece molded polymer structures. During assembly, the intermediate structure 12 and cover panel 14 may be interconnected, and posts 40 may be heat staked as described above. The NFC module 10 may then be snapped into position in the opening 22 of intermediate structure 12. For example, the NFC module 10 may be positioned adjacent rear side 48 of intermediate structure 12, and the NFC module 10 may be shifted into opening 22 whereby the connectors 20A and 20B of intermediate structure 12 engage NFC module 10, and the NFC module 10 is then snapped in place in opening 22, thereby securing NFC module 10 to intermediate structure 12. The cable 11 of NFC module 10 may then be connected to wiring harness 15 (FIG. 3) utilizing a suitable connector such as receptacle 13. The intermediate structure 12 may then be secured to the main instrument panel substrate 55 by inserting attachment structures 49 of intermediate structure 12 into openings 52 of main instrument panel substrate 55. The assembly (NFC module 10, intermediate structure 12, cover panel 14, and main instrument panel substrate 55) may then be secured to the vehicle body structure 2.

Because the intermediate structure 12 includes connectors 20A and 20B that permit the NFC module 10 to be secured to the intermediate structure 12 without the use of threaded fasteners, the intermediate structure 12 eliminates the need for a separate bracket, threaded fasteners, and other such connecting features.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. An instrument panel assembly for motor vehicles, the instrument panel assembly comprising:
a main instrument panel substrate that is configured to be secured to a motor vehicle body structure adjacent to a driver's space;
an intermediate structure secured to the main instrument panel substrate whereby a rear side of the intermediate structure faces the main instrument panel substrate and a front side of the intermediate structure faces away from the main instrument panel substrate, the intermediate structure including an opening therethrough and a plurality of barbed connectors extending from the rear side of the intermediate structure around the opening;
a Near Field Communication (NFC) module positioned in alignment with the opening of the intermediate structure, wherein the NFC module is retained by the barbed connectors; and
an outer panel secured to the intermediate structure and extending over at least a portion of the intermediate structure including the opening in the intermediate structure and over the NFC module, the outer panel having an inner surface facing the NFC module and an outer surface facing away from the NFC module, wherein at least a portion of the outer surface comprises a decorative class A surface.

2. The instrument panel assembly of claim 1, wherein:
the decorative class A surface of the outer panel comprises an in-mold grain.

3. The instrument panel assembly of claim 1, wherein:
the instrument panel assembly comprises a molded polymer structure; and
the barbed connectors comprise barbed snap fit connectors that are integrally formed with polymer material of the intermediate structure.

4. The instrument panel assembly of claim 3, wherein:
the barbed snap fit connectors comprise flexible post structures having tapered distal end surfaces and retaining surfaces that extend transverse from inner edges of the tapered distal end surfaces whereby, during installation of the NFC module, the NFC module initially engages the tapered distal end surfaces and flexes the post structures, followed by the post structures snapping back to an unflexed shape in which the retaining surfaces engage a surface of the NFC module to thereby retain the NFC module to the intermediate structure in the opening.

5. The instrument panel assembly of claim 4, wherein:
the NFC module has an oblong rectangular shape formed by a perimeter surface extending between front and rear surfaces of the NFC module, the perimeter surface including end segments extending between opposite side segments; and
the intermediate structure includes at least two barbed snap fit connectors adjacent each side segment of the perimeter surface of the NFC module.

6. The instrument panel assembly of claim 5, wherein:
the retaining surfaces of the barbed snap fit connectors contact the rear surface of the NFC module.

7. The instrument panel assembly of claim 6, wherein:
the front side of the intermediate structure includes a surface around the opening in the intermediate structure that is coplanar with the front surface of the NFC module;
the intermediate structure includes an upright end panel having a class A surface that is not covered by the outer panel.

8. The instrument panel assembly of claim 7, wherein:
the surface of the intermediate structure around the opening is disposed at an acute angle relative to a vertical plane;
the opening through the intermediate structure is rectangular and includes upper and lower edges adjacent upper and lower edges, respectively, of the NFC module; and
the intermediate structure includes a plurality of upper and lower barbed snap fit connectors adjacent the upper and lower edges, respectively, of the opening through the intermediate structure, wherein the flexible post structures of the upper and lower barbed snap fit connectors each define a length and a width in cross section, and wherein the lower barbed snap fit connectors have widths that are greater than widths of the upper barbed snap fit connectors.

9. The instrument panel assembly of claim 1, wherein:
the main instrument panel substrate includes a plurality of openings and at least one retaining clip structure adjacent each opening; and
the intermediate structure includes a plurality of tapered protrusions projecting from the rear side of the intermediate structure, wherein the tapered protrusions are disposed in the openings of the main instrument panel substrate, and engage the retaining clip structures to secure the intermediate structure to the main instrument panel substrate.

10. The instrument panel assembly of claim 9, wherein:
the intermediate structure includes a plurality of upright wall sections having attachment openings therethrough; and
the outer panel includes a plurality of connecting structures that project from the inner surface of the outer panel, wherein the connecting structures are received in the attachment openings of the intermediate structure.

11. The instrument panel assembly of claim 10, wherein:
the outer panel includes locating surfaces adjacent to the connecting structures, wherein the locating surfaces engage the upright wall sections of the intermediate structure to position the outer panel relative to the intermediate structure in at least a fore-aft horizontal direction;
the outer panel includes a plurality of locating posts that are received in locating openings of the intermediate structure to at least vertically position the outer panel relative to the intermediate structure; and
the connecting structures comprise polymer heat stakes that are melt-formed to fix the outer panel to the intermediate structure.

12. A method of fabricating an instrument panel structure of a motor vehicle, the method comprising:
forming a main instrument panel substrate;
forming an intermediate structure having an opening therethrough and a plurality of connectors adjacent the opening;
forming an outer panel having an outer surface comprising a decorative class A surface;
securing an NFC module to the intermediate structure by moving the NFC module into engagement with the connectors;
attaching the intermediate structure to the outer panel; and
attaching the intermediate structure to the main instrument panel substrate.

13. The method of claim 12, wherein:
the intermediate structure is attached to the outer panel utilizing a heat staking process whereby the intermediate structure and the outer panel are brought into contact, and at least a portion of the intermediate structure and/or the outer panel is then melted.

14. The method of claim 13, wherein:
the NFC module is secured to the intermediate structure after the intermediate structure is attached to the outer panel.

15. The method of claim 14, including:
electrically connecting the NFC module to a wiring harness of the instrument panel.

16. The method of claim 15, wherein:
the intermediate structure is attached to the main instrument panel substrate after the NFC module is secured to the intermediate structure.

17. The method of claim 12, wherein:
the intermediate structure comprises molded polymer, and the connectors comprise integrally molded barbed connectors that project from a rear side of the intermediate structure.

18. The method of claim 17, wherein;
the NFC module is secured in the opening of the intermediate structure by causing the NFC module to slidably contact the barbed connectors to flex the barbed connectors whereby the NFC module snaps in place with barbs of the barbed connectors engaging a surface of the NFC module to thereby retain the NFC module in place on the intermediate structure.

19. A motor vehicle comprising:
a body structure having an interior space including a driver's space;
an instrument panel assembly disposed in the interior space in front of the driver's space, the instrument panel assembly including:
a main instrument panel substrate secured to the body;
an intermediate structure secured to the main instrument panel substrate, the intermediate structure having an opening therethrough and at least one resilient snap connector disposed adjacent to the opening;
an NFC module secured to the intermediate structure by the at least one resilient snap connector adjacent to the opening; and
an outer panel secured to the intermediate structure and extending over the opening in the intermediate structure and over the NFC module, the outer panel having an inner surface facing the NFC module and an outer surface facing away from the NFC module, wherein at least a portion of the outer surface comprises a decorative class A surface.

20. The motor vehicle of claim 19, wherein:
the NFC module has a rectangular perimeter;
the opening is rectangular and the NFC module is closely received in the opening;
the intermediate structure comprises polymer, and the at least one resilient snap connector comprises a plurality of cantilevered barbed connectors extending from a rear side of the intermediate structure adjacent at least two opposite side edges of the rectangular opening; and
the NFC module is connected to an instrument panel wiring harness by an electrical line extending from the NFC module to the instrument panel wiring harness.
